(19) United States
(12) Patent Application Publication
(10) Pub. No.: US 2012/0124428 A1
(43) Pub. Date: May 17, 2012

(54) METHOD AND SYSTEM FOR TESTING SOFTWARE ON PROGRAMMABLE DEVICES

(76) Inventors: Thomas M. ZENG, San Diego, CA (US); Richard A. STEWART, San Diego, CA (US)

(21) Appl. No.: 12/948,740

(22) Filed: Nov. 17, 2010

(51) Int. Cl. G06F 11/34

(52) U.S. Cl. 714/45; 714/E11.2

(57) ABSTRACT

A system and method for evaluating programmable device systems captures, categorizes, indexes, manipulates and stores generated embedded trace generated information in an enterprise database. Use cases may be executed on an ETM enabled processor, ETM trace data may be captured, and captured trace data may be manipulated and stored in the enterprise database. The data collected from numerous use cases over multiple executions may be used to generate a differential comparison. The differential comparison may be used to interpret and predict bottlenecks, bugs and irregularities within the programmable device.

### FIELD OF INVENTION

The methods and systems described below relate to the field of software testing and development, and more particularly to methods and systems for simulating, testing and debugging of software in programmable devices with processors configured with embedded trace capabilities.

### BACKGROUND

Testing software components is an important aspect of designing and developing programmable mobile electronic devices, such as cellular phones. During the process of designing and developing programmable devices, many tests are executed on each device to verify device characteristics, functionality, performance, security, error handling capability etc. Once the programmable device is released, quality assurance tests are routinely conducted to improve device performance, respond to customer feedback, and to ensure customer satisfaction. Also, there is often a need to identify the source of problems that are experienced in the field by mobile devices after they have been deployed so that corrective measures can be developed and deployed.

In order to properly execute such tests and diagnostic investigations, quality assurance specialists and end users typically execute the various features offered by the programmable device and report unexpected behavior and/or bugs. Software test engineers may develop use cases replicating the environment and processes that led to the unexpected behavior and/or bugs. Each use case may be executed on hardware replicating the programmable device and trace data may be collected from the execution.

Developing such use-cases is a time-intensive process and requires the configuration of numerous parameters. Also, each use-case execution generates a large amount of trace data, which must be analyzed to identify the source of the non-conformity, unexpected behavior and/or bug. Once the source of the problem is identified, the use case data and trace data are discarded.

### SUMMARY OF THE INVENTION

Various embodiments are presented for systems and methods that provide for efficient troubleshooting and debugging of programmable device systems having processors configured with embedded instruction and data trace capabilities (referred to herein as embedded trace). In one embodiment, a use case may be derived based on an identified performance issue and/or bug. Once a use case is derived, the programmable device may be connected to embedded trace hardware and the use case duplicated on the embedded trace station. The use case may then be executed and the embedded trace data captured. Along with this embedded trace, relevant instruction flow data, state information and timing information may be extracted. This information may be then used to generate embedded trace data packages including at least one of: a program flow trace; a task modules list; software meta information; hardware meta information; use case specification; and a data flow trace.

Once the embedded trace data packages are generated, the embedded trace data packages may be inserted into a performance database to allow non-standard performance metrics to be extracted in later stages. Then, standard performance metrics (performance data) may be extracted from the embedded trace data packages. The performance data may be filtered, categorized, supplemented with metadata, indexed and stored in a database. After the performance data is stored, an intelligent comparison algorithm (herein smart diff) may be executed to generate comparison data between the newly stored data and previously stored performance data. The comparison data may be extracted from the smart diff tool and stored in an enterprise database.

In another embodiment, the values of data variables may be recorded at designated breakpoints and used to assist in the generation of the embedded trace data packages.

In another embodiment, the smart diff tool may be used to compare differences in predefined software logic blocks (herein functions) that are shared across multiple executions. Smart diff may be used these differences to generate information to be stored in the enterprise database. In yet another embodiment, smart diff may be used to analyze the impact of functions not present in previous executions on a particular use case. In yet another embodiment, smart diff may be used to analyze the impact of functions present in previous executions, yet not present in the current execution.

In another embodiment, the results of the smart diff comparison may be indexed and stored in an enterprise database such that this data may be accessed via a client application.

In another embodiment, smart diff may be used to analyze ETM trace packages across the time dimension and store the results in the enterprise database.

In another embodiment, smart diff may be used to analyze embedded trace data packages across the chipset dimension and store the results in the enterprise database.

In another embodiment, smart diff may be used to analyze embedded trace data packages across the use case dimension and store the results in the enterprise database.

In another embodiment, the client application may present users with an advanced search interface, allowing the enterprise database to be searched across the time dimension, the chipset dimension, and the use case dimension.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 is a data table showing a sample visual display of embedded trace data.

FIG. 2 is a data display showing a sample visual graph usable to analyze and interpret embedded trace data.

FIG. 3 is a data display showing alternative visual graph usable to analyze and interpret embedded trace data.

FIG. 4 is a process flow diagram of an embodiment method for updating the enterprise database with the execution of use cases.

FIG. 5 is a data structure diagram showing elements of an embedded trace data package.

FIG. 6 is a process flow diagram of an embodiment method for a client application interacting with the enterprise database.

FIG. 7 is a process flow diagram of an embodiment method of a server application.

FIG. 8 is a process component block diagram showing various function elements of the smart diff post processing of embedded trace packages.

FIG. 9 is a component block diagram of an exemplary programmable device.

FIG. 10 is a component block diagram of a computer suitable for use with the various embodiments.

FIG. 11 is a system block diagram of a client-server system suitable for implements the various embodiments.

### DETAILED DESCRIPTION OF THE PREFERRED EMBODIMENTS

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

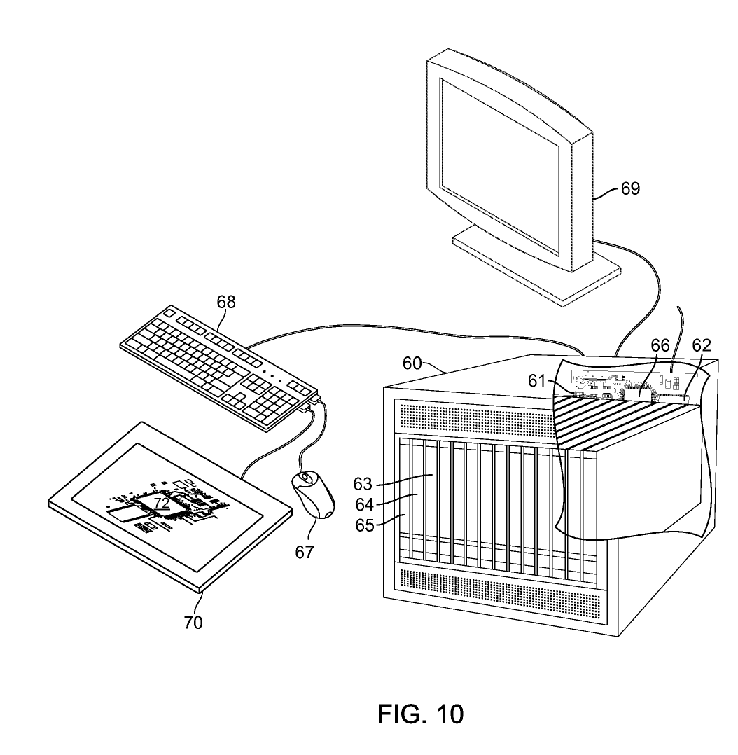

As used herein, the terms “programmable device” and “mobile device” are used interchangeably and refer to any one of various cellular telephones, personal mobile television receivers, tablet computers, personal data assistants (PDA's), palm-top computers, laptop computers, wireless electronic mail receivers (e.g., the Blackberry® and Treo® devices), and Internet enabled cellular telephones (e.g., the Blackberry Storm®), and similar personal electronic devices. A mobile device may include a programmable processor and memory as described more fully below with reference to FIG. 10.

The testing and debugging of mobile devices typically involves creating use cases, or highly detailed and exhaustive test cases, which involve a time-intensive process that requires the configuration of numerous parameters. Executing a use case generates a large amount of trace data for analysis in order to identify the source of an identified non-conformity, unexpected behavior and/or bug.

Currently, use case data and trace data are discarded once the source of a problem is identified. It would be advantageous to provide a system and method that allows for the reuse of use cases and trace data. This is especially true for troubleshooting and debugging of mobile device systems implemented with processors configured with embedded trace capabilities, such as embedded trace macrocells (ETMs).

As used herein, the term “embedded trace” refers to any of a variety of technologies and software/hardware systems that enable real-time or near real-time collection of instruction execution and data transfers for use in development and debugging of embedded systems and software. A variety of such capabilities are available, including capabilities for real-time tracking of processor operations, instruction execution, bus transactions, and memory accesses. As used herein “embedded trace macrocell” and “ETM” refer generally to such embedded instruction/data transaction tracking capabilities, one example of which is the CoreSight™ Embedded Trace Macrocell™ technology licensed by ARM Ltd. However, references to “embedded trace macrocell” and “ETM” are not intended to limit the scope of the claims to a particular embedded trace technology or product.

ETMs are logic gates embedded into select modern processors, such as those made or licensed by ARM Ltd., that provide built-in debug and trace facilities. Specifically, ETMs collect instruction and data transfer information, compress this information and deliver the information, in real-time, to an external device for post processing. That is, ETMs send information regarding a processor's execution (for example, step-by-step functioning in the processor) to a separate device specifically designed to communicate with the ETM and collect the data. This allows the processor's information to be captured for use in testing and trouble shooting, while adding little or no burden to the processor's performance.

However, debugging software using ETMs is somewhat cumbersome and problematic. For instance, using an ETM requires expensive hardware, extensive training, and time-consuming use-case data generation. Further, ETMs generate a lot of trace information, which can be cumbersome to store, process and analyze. This is partially due to the fact that ETMs generate many gigabytes of trace data—the vast majority of which is simply disregarded or discarded. One reason the embedded trace data is discarded is that there is no facility for storing and retrieving such data.

The various embodiments overcome limitations of prior practice by providing for systematic storage and reuse of ETM trace data and other data generated in the process of testing and trouble shooting mobile devices. In the various embodiments systems and methods provide for efficient troubleshooting and debugging of programmable device systems having processors built with ETMs. A use case may be derived based on an identified performance issue and/or bug. Using the derived use case, the use case may be duplicated with the programmable device connected to ETM hardware and an ETM station. The resulting ETM trace data may be captured, from which relevant instruction flow data, state information and timing information may be extracted. This information may be used to generate ETM trace data packages such as program flow traces, task modules lists, software meta information, hardware meta information, use case specifications, and data flow traces. Performance data may be extracted from the ETM trace packages, and the performance data may be filtered, categorized, supplemented with metadata, indexed and stored in a database. Stored performance data may be analyzed by an intelligent comparison algorithm (which is referred to herein as “smart diff”) to generate comparison data contrasting newly stored data with previously stored performance data. Such comparison data may be extracted from the smart diff tool and stored in an enterprise database. The values of data variables may be recorded at designated breakpoints and used to assist in the generation of the ETM trace packages. The smart diff tool may be used to compare differences in predefined software logic blocks or functions that are shared across multiple executions. Smart diff may use these differences to generate information to be stored in the enterprise database. Smart diff may also be used to analyze the impact of functions not present in previous executions on a particular use case or versions of a mobile device being tested. Smart diff may also be used to analyze the impact of functions present in previous executions, yet not present in the current execution. In an embodiment, the results of the smart diff comparison may be indexed and stored in the enterprise database in a manner that enables this data to be accessed via a client application. With data stored in an enterprise database, smart diff may be used to analyze ETM trace data packages across the time dimension.

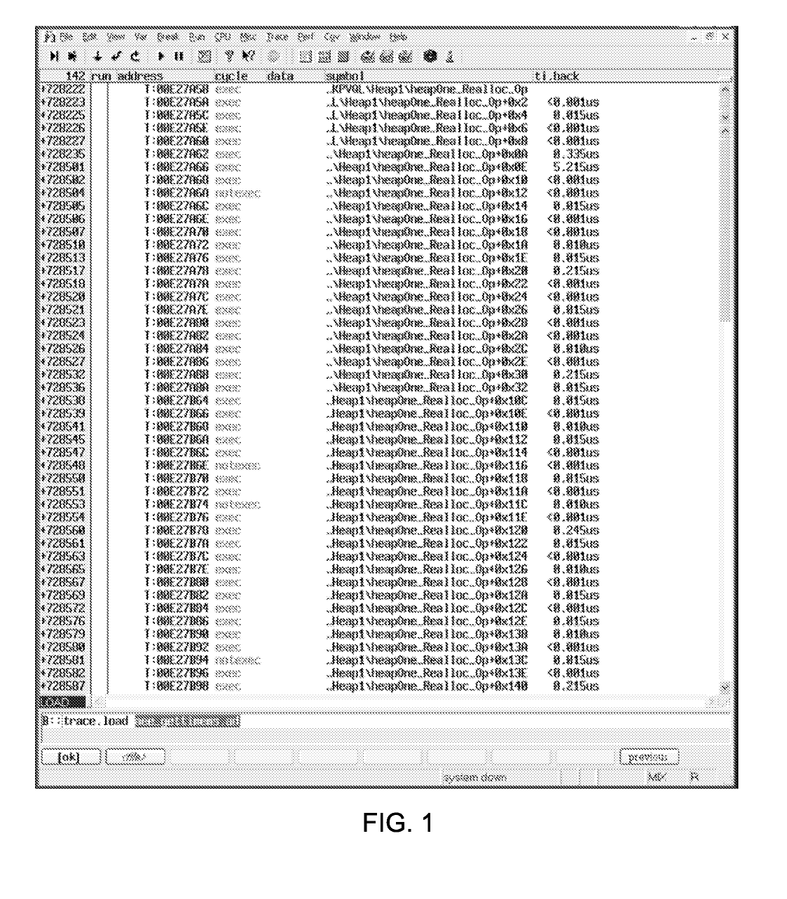

FIG. 1 shows a listing of sample ETM trace data. As is evident from FIG. 1, the ETM trace data typically contains raw, low level execution information. Thus, analyzing and interpreting such ETM trace data is cumbersome and time consuming.

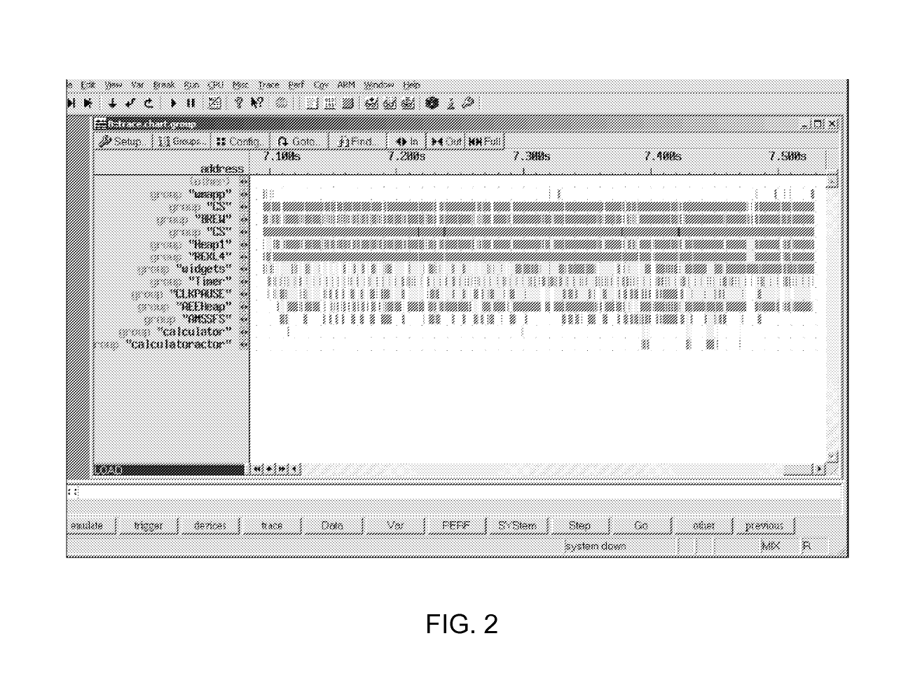

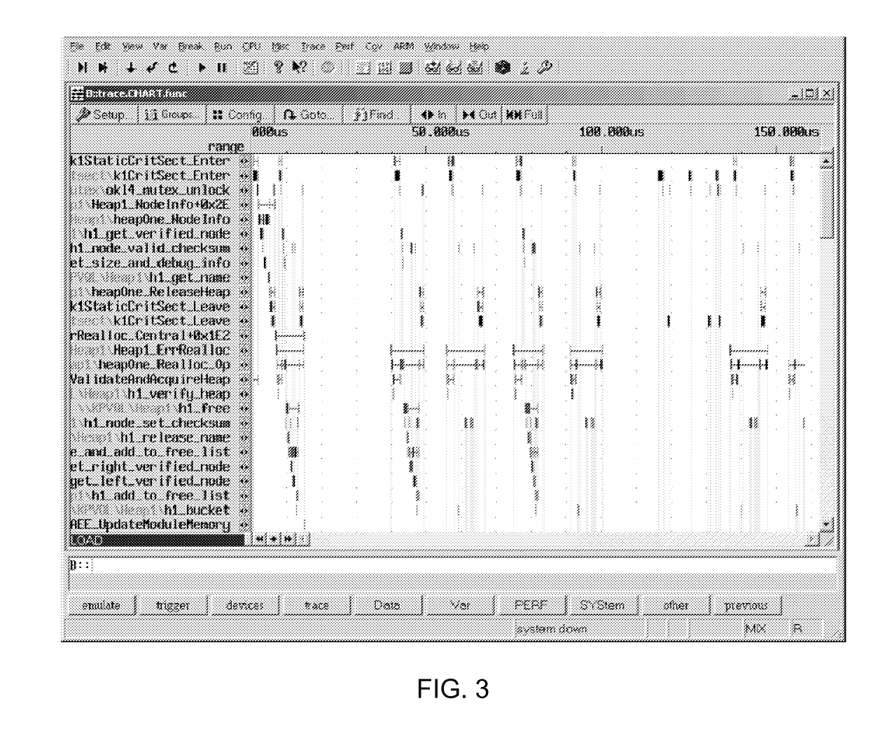

Currently, there are tools that can be used to process generated trace information and display the results of the trace information in a visual format. FIGS. 2 and 3 show sample visual graphs displaying ETM trace data in a more understandable format. However, these tools simply analyze a single execution of a single use case, and do not store, categorize or interpret multiple use cases over multiple executions.

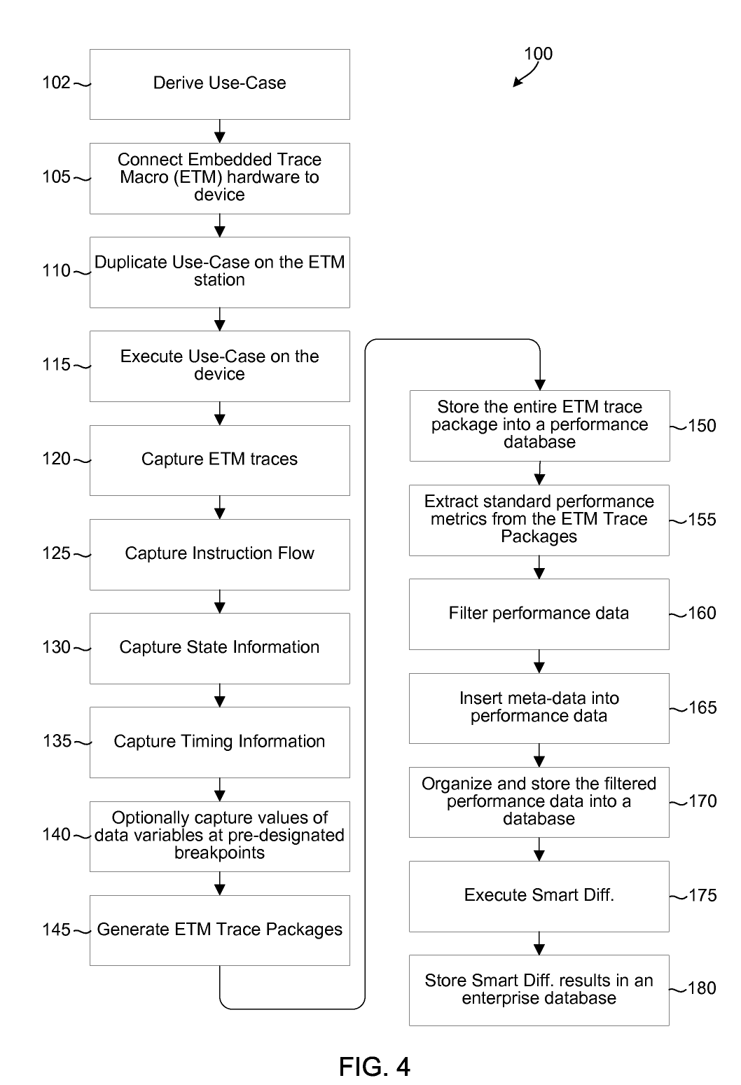

An embodiment method 100 for reusing test and use-case data to generate a trace data is illustrated in FIG. 4. In method 100 in step 102, a use case, or a highly detailed and exhaustive test case, is created in a manner that replicates a reported unexpected behavior and/or bug. Alternatively, a use-case may be created in such manner as to be capable of verifying device characteristics, functionality, performance, security, or error handling capabilities.

Once a use case is derived in step 102, a programmable device may be connected to an ETM device in step 105. This may be achieved, for example, by opening up communication lines between the programmable device and the ETM device using software network connection utilities. With the connection established between the programmable device and the ETM, the use case may be duplicated and transferred onto the ETM station in step 110. In step 115, the use-case may be executed on the programmable device and the ETM traces are captured and stored in memory of the ETM station.

In an embodiment, once the ETM traces are captured and stored in memory, instruction flow data may be extracted in step125. This may be accomplished by analyzing the trace data to identify and count or copy those traces associated with instruction branching operations. In step 130, state information may be extracted from the trace data, such as by selecting and recording individual state data. In step 135, timing information 135 may be extracted from the ETM traces, such as by noting the recorded time associated with particular operations or by noting a time difference between the start of one operation and the beginning of the next. In an embodiment, the values of data variables may be captured at pre-designated breakpoints in step 140. In another embodiment, the extraction of instruction flow data (step 125), state information (step 130), and timing information (step 135) may be extracted during the execution of the use case at the same time that the ETM traces are captured.

After the ETM trace information has been extracted and captured, this information may be used along with the captured instruction flow data captured in step 125, state information capture in step 130, and timing information captured in step 135 to generate ETM trace data packages in step 145. These ETM trace data packages may then be stored in a performance database in step 150. Storing the entire content of the ETM trace data packages allows non-standard performance metrics to be extracted in later stages. In an embodiment, the ETM trace data packages generated in step 145 may be stored in a database in step170. Any suitable database may be used for such purposes. In an embodiment, pre-configured processes may be executed on the ETM trace data packages in such manner as to extract relevant performance metrics (performance data) in step155. This performance data may then be filtered in step160, and embedded with metadata in step 165 before being stored in the database in step170. Such metadata may serve as an index or search terms for cataloging the information archived within the performance data and the original ETM trace data packages stored in the database. The performance data may also be organized and categorized as part of storing it in the database in step170.

Once the ETM trace data packages and/or performance data have been stored in the database, an intelligent comparator program (smart diff), may be executed on the newly entered database information in step175. Specifically, smart diff may be executed to compare the newly inserted information with previously stored information. Data similarities and differences may be analyzed in this process so as to determine how the use case has resulted in different performance, as well has how portions of the operations remain the same as in other or prior use cases. Also, a technical description of the difference between the data sets may be generated, (herein referred to as a differential comparison). This differential comparison may be categorized, analyzed, and stored in an enterprise database in step180. This process may be repeated for many use cases in order to generate a database of data across a range of uses and operational circumstances.

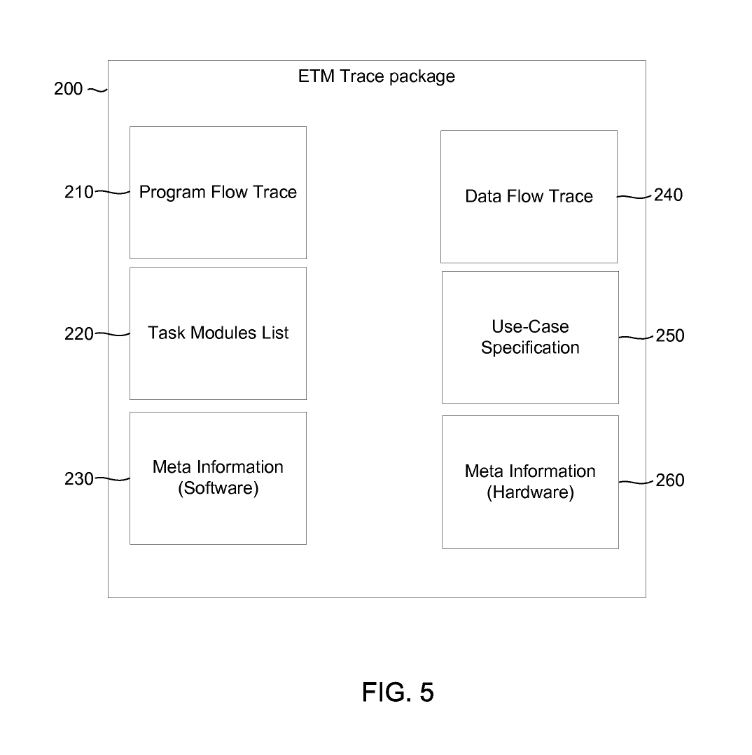

Data components making up an ETM trace data package 200 are illustrated in FIG. 5. The ETM trace data package 200 may include a program flow trace 210 which is a program listing of the structured program that can be used to show the structure and flow of control. Specifically, the program flow trace 210 may contain information regarding the real-time instruction flow and, thus, contain information useable to reconstruct the execution. The ETM trace data package 200 may include a task modules list 220 which includes information regarding the execution of each task or routine of interest. The ETM trace data package 200 may include software meta information 230 which includes information about the exact version and configuration of the software used in the execution. The ETM trace data package 200 may include hardware meta information 240 which includes information about the exact version and configuration of the hardware used during execution. The ETM trace data package 200 may include a use case specification 250 which provides details regarding the particular use-case that was run on the ETM enabled processor to generate the results. The ETM trace data package 200 may include a data flow trace 250 which includes information regarding the values of variables at various pre-defined locations and times in the execution.

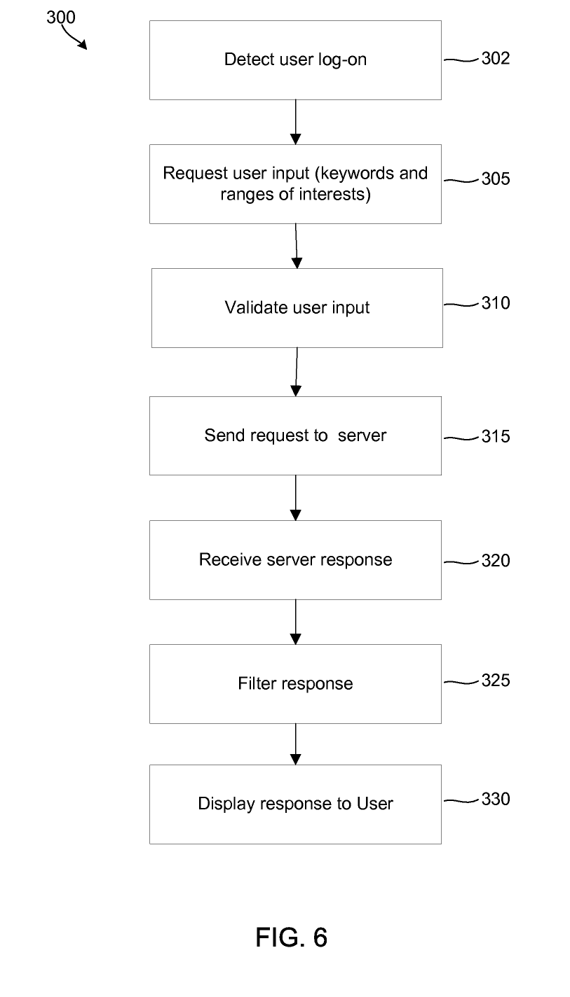

An embodiment method 300 for using a client application to access the enterprise database is illustrated in FIG. 6. In method 300 in step 302, the client application may detect that a user desires to access the enterprise database, and in response, authenticate the user's privileges, and log the user onto the system. in step 304, the client application may prompt the user for an input. This input may include various parameters relevant to the stored trace data and extracted information, such as keywords and ranges of interest. In step 310 the user's input may be validated. A request package may be created and sent to a server application in step 315. After sending the request package to the server, the client application may wait for a response from the server. When a response is received in step 320, the response may be filtered in step 325 and displayed to the user in step 330.

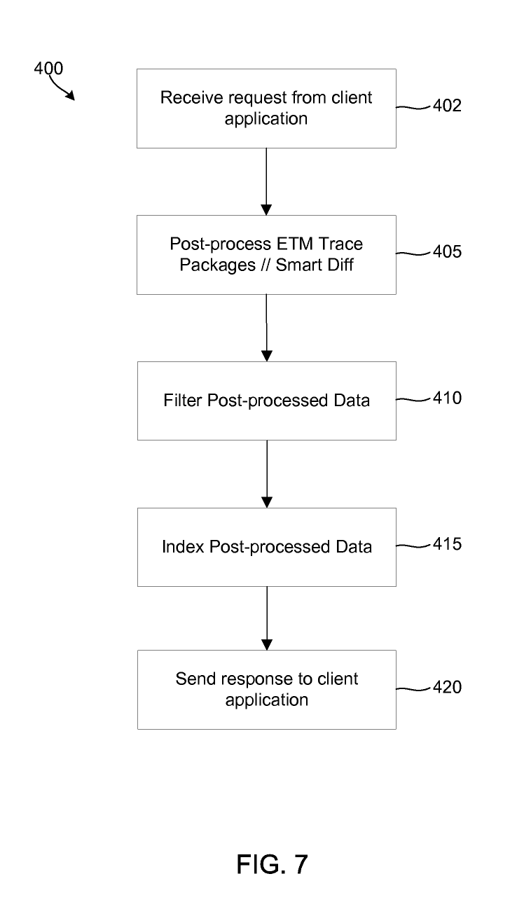

FIG. 7 shows An embodiment method 400 for using a server application to access the enterprise database in response to the client application's request for information is illustrated in FIG. 7. It should be noted that the server application may be on the same machine as the client application, or on a dedicated server across a LAN or WAN.

Referring to FIG. 7, in method 400 in step 402, the server application may receive a request from the client application. In response, the server may search the enterprise database for the requested information, or run the smart diff program to generate the requested information in step 405. If the server application executes the smart diff program, the results of the smart diff are post-processed and filtered 410 based on an array of variables contained in the client request. This filtered data may be then indexed in step 415 in order to speed up future requests for the same or similar information.

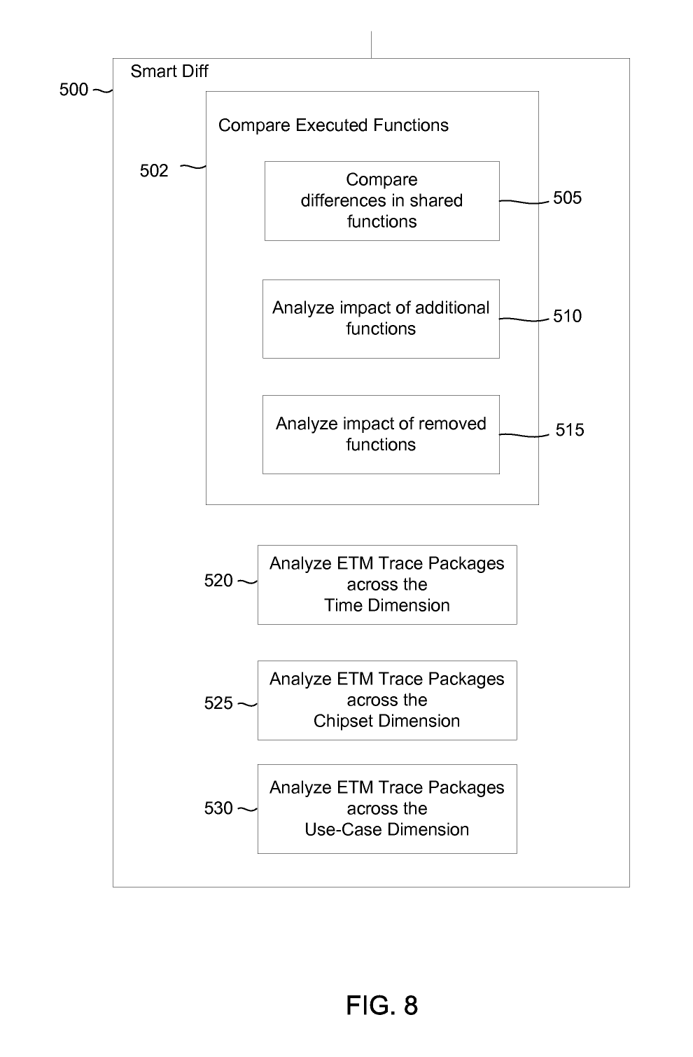

FIG. 8 illustrates process modules that may be included in an embodiment of a smart diff program 500. For instance, FIG. 8 shows that in one embodiment, the smart diff program 500 includes a compare executed functions module 502 which may be configured to compare the results of individual functions, which are shared across different executions of different use cases in module 505. In doing so, smart diff may compare the differences in performance data, which has been previously extracted and stored in a database. The similarities and differences may then be analyzed, and data may be generated to represent the variances between the individual functions. In an embodiment, the impact of additional functions (not present in otherwise similar executions) may be analyzed in module 510. In an embodiment, the impact of functions present in previous executions of similar use-cases, but lacking in the execution under evaluation, may be analyzed in module 515. In another embodiment, both the presence and absence of functions may be evaluated in modules 510 and 515.

The smart diff program may be further configured to analyze the ETM trace packages, or the extracted performance data, across a time dimension in module 520. Similarly, smart diff may be configured to analyze the ETM trace data packages and extracted performance data across a chipset dimension in module 525. Additionally, smart diff may be configured to analyze the ETM trace data packages and extracted performance data across a use case dimension in module 525. Further, for each of these dimensions of analysis, smart diff may be configured to evaluate one or more executions or use cases against other individual executions or use cases, a selected number of executions or use cases, or against all executions and use cases for which data is stored in the database.

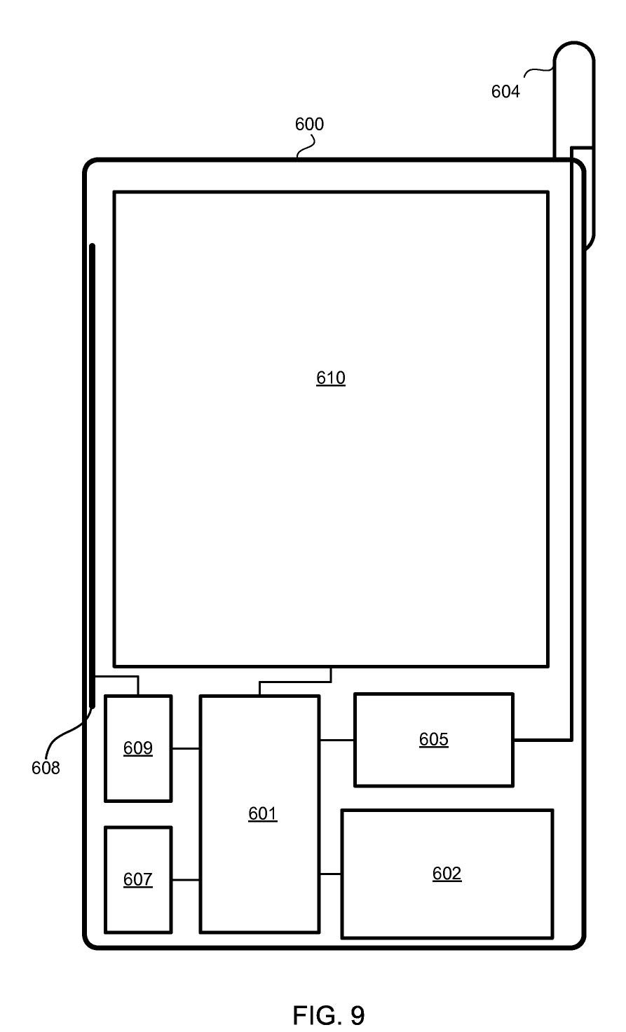

FIG. 9 illustrates that an exemplary programmable device 600 suitable for use with the various aspects will have certain common components. For example, an exemplary programmable device 600 may include a processor 601 coupled to internal memory 602 and a touchscreen display 610. Additionally, the programmable device 600 may have an antenna 604 for sending and receiving electromagnetic radiation that is connected to a wireless data link and/or cellular telephone transceiver 605 coupled to the processor 601. Some programmable devices 600 may also include an accelerometer 607 coupled to the processor 601 configured to enable the processor 601 to determine the horizontal versus vertical orientation of the mobile device 600 by sensing the gravity gradient.

In an embodiment, the programmable device 600 may further include a touch sensor 608 separate from the touchscreen display 610, which is coupled to the processor 601, such as via a touch sensor processing circuit 609, and positioned on or near a case of the mobile device 600. Such a touch sensor 608 may be a differential capacitance sensor, differential inductance sensor, thermal sensor, pressure sensor, ultrasound vibrations sensor, or any other sensor capable of detecting the touch of a user's hand and/or fingers to the case. Such a touch sensor 608 may be positioned on the sides and back of the mobile device 600 case, as well as long the bezel surrounding the touchscreen display 610.

The mobile device processor 601 may be any programmable microprocessor, microcomputer or multiple processor chip or chips that can be configured by software instructions (applications) to perform a variety of functions, including the functions of the various aspects described herein. In some mobile devices, multiple processors 601 may be provided, such as one processor dedicated to wireless communication functions and one processor dedicated to running other applications. Typically, software applications may be stored in the internal memory 602 before they are accessed and loaded into the processor 601. In some mobile devices, additional memory chips (e.g., a Secure Data (SD) card) may be plugged into the mobile device 600 and coupled to the processor 601. In many mobile devices, the internal memory 602 may be a volatile or nonvolatile memory, such as flash memory, or a mixture of both. For the purposes of this description, a general reference to memory refers to all memory accessible by the processor 601, including internal memory 602, removable memory plugged into the mobile device, and memory within the processor 601 itself.

The embodiments described above may also be implemented on any of a variety of computers, such as a workstation computer 60 illustrated in FIG. 10. Such a workstation computer 60 typically includes a processor 61 coupled to volatile memory 62 and a large capacity nonvolatile memory, such as a disk drive 63. The computer 60 may also include a removable disc drive 64 and a compact disc (CD) drive 65 coupled to the processor 61. Typically the computer 60 will also include a pointing device such as a mouse 67, a user input device such as a keyboard 68 and a display 66. The computer 60 may also include a number of network connection circuits 66, such as a USB or FireWire®, coupled to the processor 61 for establishing data connections to external devices such as a programmable device being tested. The workstation computer 60 may also be coupled to an embedded trace interface device 70, such as an ETM device, on which may be mounted a processor system 72 for testing. As described above, the embedded trace interface device 70 may be configured with electrical connections for connecting to an ETM enabled processor system 72 and configured to interact with the processor to initiate processes while receiving ETM trace data which the embedded trace interface device 70 may send to the workstation computer 60 for processing and storage in accordance with the embodiments.

The various embodiments may be implemented by a computer processor 61 executing software instructions configured to implement one or more of the described methods. Such software instructions may be stored in memory 62, 63 as separate applications, or as compiled software implementing an embodiment method. Reference database may be stored within internal memory 62, in hard disc memory 64, on tangible storage medium or on servers accessible via a network (not shown). Further, the software instructions and databases may be stored on any form of tangible processor-readable memory, including: a random access memory 62, hard disc memory 63, a floppy disc (readable in a floppy disc drive 64), a compact disc (readable in a CD drive 65), electrically erasable/programmable read only memory (EEPROM), read only memory (such as FLASH memory), and/or a memory module (not shown) plugged into the computer 60, such as an external memory chip or a USB-connectable external memory (e.g., a “flash drive”) plugged into a USB network port 66.

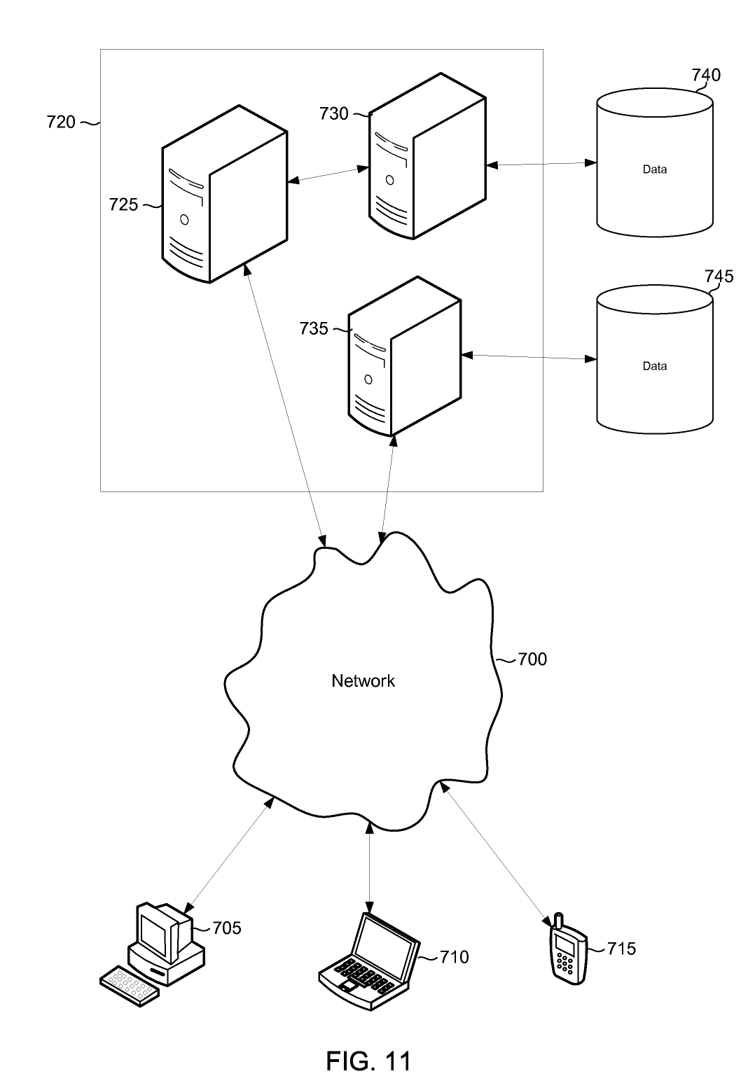

The embodiments described above may also be implemented on any of a variety of client-server systems, as illustrated in FIG. 11. The client application may run on any processor executing software instructions, such as those found in personal computers 705, laptop computers 710, and mobile handheld devices 715. The client application may send a request for information across a local or wide area network 700 to a server system 720. The server system 720 may include one or more servers 725, 730 and 735. The servers 725, 730 and 735 may either immediately handle the request for information—or interact with one or more databases 740 and 745 to extract the requested information and send the extracted information to the client application.

The foregoing method descriptions and process flow diagrams are provided merely as illustrative examples and are not intended to require or imply that the steps of the various aspects must be performed in the order presented. As will be appreciated by one of skill in the art the order of steps in the foregoing aspects may be performed in any order. Further, references to step identifiers and words such as “thereafter,” “then,” “next,” etc. are not intended to limit the order of the steps; such identifiers and words are simply used to guide the reader through the description of the methods.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A method of debugging programmable device systems including a processor configured with embedded trace capabilities, the method comprising:
executing a process on the processor;
capturing embedded trace data from the processor for the executed process;
generating at least one embedded trace data package from the captured embedded trace data;
storing the generated embedded trace data package in a database;
executing an intelligent comparator program on the database to generate a differential comparison; and
storing the differential comparison in an enterprise database.

2. The method of claim 1, further comprising:
extracting performance data from the generated embedded trace data package; and
storing the extracted performance data in the enterprise database.

3. The method of claim 1, wherein execution of the intelligent comparator program compares newly inserted database information with previously inserted database information.

4. The method of claim 3, wherein execution of the intelligent comparator program analyzes data similarities between the newly inserted database information and the previously inserted database information and generates a technical description of the difference between the data sets.

5. The method of claim 1, wherein execution of the intelligent comparator program analyzes the embedded trace data packages across a time dimension.

6. The method of claim 1, wherein execution of the intelligent comparator program analyzes the embedded trace data packages across a chipset dimension.

7. The method of claim 1, wherein execution of the intelligent comparator program analyzes the embedded trace data packages across a use case dimension.

8. The method of claim 1, wherein execution of the intelligent comparator program evaluates one or more executions against other individual executions.

9. The method of claim 1, wherein execution of the intelligent comparator evaluates one or more executions against the entire database.

10. The method of claim 1, wherein generating at least one embedded trace data package from the captured embedded trace data generates an embedded trace data package containing:
a program flow trace;
a task modules list;
software meta information;
hardware meta information;
a use case specification; and
a data flow trace.

11. The method of claim 1, further comprising extracting additional instruction flow data, state information and timing information from the ETM enabled processor,
wherein generating at least one embedded trace data package from the captured embedded trace data package comprises using the additional instruction flow data, state information and timing information along with the embedded trace data to generate the embedded trace data package.

12. The method of claim 1, wherein the embedded trace capabilities of the processor comprise an embedded trace macrocell (ETM), and wherein:
capturing embedded trace data from the processor for the executed process comprises capturing ETM trace data from the processor for the executed process;
generating at least one embedded trace data package from the captured embedded trace data comprises generating at least one ETM trace data package from the captured ETM trace data; and
storing the generated embedded trace data package in a database comprises storing the generated ETM trace data package in the database.

13. A system for debugging programmable device systems including a processor configured with embedded trace capabilities, the system comprising:
a computer;
a database memory coupled to the computer; and
an embedded trace interface device coupled to the computer and configured to:
interface with the programmable device system to cause processes to execute on the processor and to receive embedded trace data from the processor;
receive commands from the computer; and
send received embedded trace data to the computer;
wherein the computer is configured with computer-executable instructions to perform operations comprising:
signaling the embedded trace interface to cause the processor to execute a process;
receiving captured embedded trace data from the embedded trace interface for the executed process;
generating at least one embedded trace data package from the captured embedded trace data;
storing the generated embedded trace data package in a database on the database memory;
executing an intelligent comparator program on the database to generate a differential comparison; and
storing the differential comparison in an enterprise database on the database memory.

14. The system of claim 13, wherein the computer is configured with computer-executable instructions to perform operations further comprising:
extracting performance data from the generated embedded trace data package; and
storing the extracted performance data in the enterprise database.

15. The system of claim 13, wherein the computer is configured with computer-executable instructions to perform operations such that execution of the intelligent comparator program compares newly inserted database information with previously inserted database information.

16. The system of claim 15, wherein the computer is configured with computer-executable instructions to perform operations such that execution of the intelligent comparator program analyzes data similarities between the newly inserted database information and the previously inserted database information and generates a technical description of the difference between the data sets.

17. The system of claim 13, wherein the computer is configured with computer-executable instructions to perform operations such that execution of the intelligent comparator program analyzes the embedded trace data packages across a time dimension.

18. The system of claim 13, wherein the computer is configured with computer-executable instructions to perform operations such that execution of the intelligent comparator program analyzes the embedded trace data packages across a chipset dimension.

19. The system of claim 13, wherein the computer is configured with computer-executable instructions to perform operations such that execution of the intelligent comparator program analyzes the embedded trace data packages across a use case dimension.

20. The system of claim 13, wherein the computer is configured with computer-executable instructions to perform operations such that execution of the intelligent comparator program evaluates one or more executions against other individual executions.

21. The system of claim 13, wherein the computer is configured with computer-executable instructions to perform operations such that execution of the intelligent comparator evaluates one or more executions against the entire database.

22. The system of claim 13, wherein the computer is configured with computer-executable instructions to perform operations such that generating at least one embedded trace data package from the captured embedded trace data generates an embedded trace data package containing:
a program flow trace;
a task modules list;
software meta information;
hardware meta information;
a use case specification; and
a data flow trace.

23. The system of claim 13, wherein the computer is configured with computer-executable instructions to perform operations further comprising extracting additional instruction flow data, state information and timing information from the ETM enabled processor, and
wherein the computer is configured with computer-executable instructions to perform operations such that generating at least one embedded trace data package from the captured embedded trace data package comprises using the additional instruction flow data, state information and timing information along with the embedded trace data to generate the embedded trace data package.

24. The system of claim 13, wherein:
the embedded trace capabilities of the processor comprise an embedded trace macrocell (ETM);
the embedded trace interface device comprises an ETM device; and
the computer is configured with computer-executable instructions to perform operations such that:
capturing embedded trace data from the processor for the executed process comprises capturing ETM trace data from the processor for the executed process;
generating at least one embedded trace data package from the captured embedded trace data comprises generating at least one ETM trace data package from the captured ETM trace data; and
storing the generated embedded trace data package in a database comprises storing the generated ETM trace data package in the database.

25. A system for debugging programmable device systems including a processor configured with embedded trace capabilities, the system comprising rising:
means for executing a process on the processor;
means for capturing embedded trace data from the processor for the executed process;
means for generating at least one embedded trace data package from the captured embedded trace data;
means for storing the generated embedded trace data package in a database;
means for executing an intelligent comparator program on the database to generate a differential comparison; and
means for storing the differential comparison in an enterprise database.

26. The system of claim 25, further comprising:
means for extracting performance data from the generated embedded trace data package; and
means for storing the extracted performance data in the enterprise database.

27. The system of claim 25, wherein means for executing an intelligent comparator program comprises means for comparing newly inserted database information with previously inserted database information.

28. The method of claim 27, wherein means for executing an intelligent comparator program comprises means for analyzing data similarities between the newly inserted database information and the previously inserted database information and generates a technical description of the difference between the data sets.

29. The system of claim 25, wherein means for executing an intelligent comparator program comprises means for analyzing the embedded trace data packages across a time dimension.

30. The system of claim 25, wherein means for executing an intelligent comparator program comprises means for analyzing the embedded trace data packages across a chipset dimension.

31. The system of claim 25, wherein means for executing an intelligent comparator program comprises means for analyzing the embedded trace data packages across a use case dimension.

32. The system of claim 25, wherein means for executing an intelligent comparator program comprises means for evaluating one or more executions against other individual executions.

33. The system of claim 25, wherein means for executing an intelligent comparator program comprises means for evaluating one or more executions against the entire database.

34. The system of claim 25, wherein means for generating at least one embedded trace data package from the captured embedded trace data comprises means for generating an embedded trace data package containing:
a program flow trace;
a task modules list;
software meta information;
hardware meta information;
a use case specification; and
a data flow trace.

35. The system of claim 25, further comprising means for extracting additional instruction flow data, state information and timing information from the ETM enabled processor,
wherein means for generating at least one embedded trace data package from the captured embedded trace data package comprises means for using the additional instruction flow data, state information and timing information along with the embedded trace data to generate the embedded trace data package.

36. The system of claim 25, wherein the embedded trace capabilities of the processor comprise an embedded trace macrocell (ETM), and wherein:
means for capturing embedded trace data from the processor for the executed process comprises means for capturing ETM trace data from the processor for the executed process;
means for generating at least one embedded trace data package from the captured embedded trace data comprises means for generating at least one ETM trace data package from the captured ETM trace data; and
means for storing the generated embedded trace data package in a database comprises means for storing the generated ETM trace data package in the database.

37. A non-transitory computer readable storage medium having stored thereon computer-executable instructions configured to cause a computer of a system for debugging programmable device systems including a processor configured with embedded trace capabilities to perform operations comprising:
signaling an embedded trace interface to cause the processor to execute a process;
receiving captured embedded trace data from the embedded trace interface for the executed process;
generating at least one embedded trace data package from the captured embedded trace data;
storing the generated embedded trace data package in a database;
executing an intelligent comparator program on the database to generate a differential comparison; and
storing the differential comparison in an enterprise database.

38. The non-transitory computer readable storage medium of claim 37, wherein the stored computer-executable instructions are configured to cause the computer to perform operations further comprising:
extracting performance data from the generated embedded trace data package; and
storing the extracted performance data in the enterprise database.

39. The non-transitory computer readable storage medium of claim 37, wherein the stored computer-executable instructions are configured to cause the computer to perform operations such that execution of the intelligent comparator program compares newly inserted database information with previously inserted database information.

40. The non-transitory computer readable storage medium of claim 39, wherein the stored computer-executable instructions are configured to cause the computer to perform operations such that execution of the intelligent comparator program analyzes data similarities between the newly inserted database information and the previously inserted database information and generates a technical description of the difference between the data sets.

41. The non-transitory computer readable storage medium of claim 37, wherein the stored computer-executable instructions are configured to cause the computer to perform operations such that execution of the intelligent comparator program analyzes the embedded trace data packages across a time dimension.

42. The non-transitory computer readable storage medium of claim 37, wherein the stored computer-executable instructions are configured to cause the computer to perform operations such that execution of the intelligent comparator program analyzes the embedded trace data packages across a chipset dimension.

43. The non-transitory computer readable storage medium of claim 37, wherein the stored computer-executable instructions are configured to cause the computer to perform operations such that execution of the intelligent comparator program analyzes the embedded trace data packages across a use case dimension.

44. The non-transitory computer readable storage medium of claim 37, wherein the stored computer-executable instructions are configured to cause the computer to perform operations such that execution of the intelligent comparator program evaluates one or more executions against other individual executions.

45. The non-transitory computer readable storage medium of claim 37, wherein the stored computer-executable instructions are configured to cause the computer to perform operations such that execution of the intelligent comparator evaluates one or more executions against the entire database.

46. The non-transitory computer readable storage medium of claim 37, wherein the stored computer-executable instructions are configured to cause the computer to perform operations such that generating at least one embedded trace data package from the captured embedded trace generates an embedded trace data package containing:
a program flow trace;
a task modules list;
software meta information;
hardware meta information;
a use case specification; and
a data flow trace.

47. The non-transitory computer readable storage medium of claim 37, wherein the stored computer-executable instructions are configured to cause the computer to perform operations further comprising extracting additional instruction flow data, state information and timing information from the processor, and
wherein the stored computer-executable instructions are configured to cause the computer to perform operations such that generating at least one embedded trace data package from the captured embedded trace data package comprises using the additional instruction flow data, state information and timing information along with the embedded trace data to generate the embedded trace data package.

48. The non-transitory computer readable storage medium of claim 37, wherein:
the embedded trace capabilities of the processor comprise an embedded trace macrocell (ETM);
the embedded trace interface device comprises an ETM device; and
the stored computer-executable instructions are configured to cause the computer to perform operations such that:
capturing embedded trace data from the processor for the executed process comprises capturing ETM trace data from the processor for the executed process;
generating at least one embedded trace data package from the captured embedded trace data comprises generating at least one ETM trace data package from the captured ETM trace data; and
storing the generated embedded trace data package in a database comprises storing the generated ETM trace data package in the database.
